(19) United States
(12) Patent Application Publication
(10) Pub. No.: US 2023/0244872 A1
(43) Pub. Date: Aug. 3, 2023

(54) GENERATING AND IDENTIFYING TEXTUAL TRACKERS IN TEXTUAL DATA

(71) Applicant: GONG.io Ltd., Ramat Gan (IL)

(72) Inventors: Inbal HOREV, Tel Aviv (IL); Omri ALLOUCHE, Tel Aviv (IL)

(73) Assignee: GONG.io Ltd., Ramat Gan (IL)

(21) Appl. No.: 17/649,453

(22) Filed: Jan. 31, 2022

(51) Int. Cl. G06F 40/289; G06N 20/00

(52) U.S. Cl. CPC G06F 40/289; G06N 20/00

(57) ABSTRACT

A method and system for generating a tracker model for identification of trackers in textual data are provided. The method includes receiving an input query including at least an input sentence exemplifying a tracker of interest, wherein the tracker is at least one word with a specific context; generating a base results set including a set of sentences substantially matching the input sentence, wherein the sentences in the base results set are obtained from an index indexing textual data; deriving a first labeling set from the base results set, wherein includes samples of sentences from the base results set; receiving labels on each sentence in the first labeling set; and feeding the labels to a machine learning algorithm to train the tracker model, wherein the tracker model is generated and ready when enough labels have been processed by the machine learning algorithm.

### TECHNICAL FIELD

The present disclosure generally relates to processing textual data, more specifically to techniques for identifying, labeling, and tracking concepts in textual data.

### BACKGROUND

In sales organizations, especially these days, meetings are conducted via teleconference or videoconference calls. Further, emails are the primary communication means for exchanging letter offers, follow-ups, and so on. In many organizations, sales calls are recorded and available for subsequent review. The transcribed calls and emails from a corpus of textual data. Due to the volume of records in such corpus, reviewing the records to derive insight is time-consuming, and most of the information cannot be exploited.

Insights from analyzing sales calls or other sales records can be derived and may include identification of keywords or phrases that appear in conversations saved in the textual corpus. Identification of keywords may flag meaningful conversations to follow-up on or provide further processing and analysis. For example, identifying the phrase “expensive” may be utilized to improve the sales process.

A few solutions are discussed, in the related art, to identify keywords or phrases in textual data. Such solutions are primarily based on textual searches or natural language processing (NLP) techniques. However, such solutions suffer a few limitations, including, but not limited to, the accuracy of identification of keywords and identification of keywords having a certain context. The accuracy of such identification is limited as a search is performed based on keywords taken from a predefined dictatory. As such transcription may not be accurate (e.g., background noise), the identification may not be complete if only a keyword search is applied.

Further, even if the transcription is clear and without errors, identification of keywords without understanding the context may results in incomplete identification of similar keywords or identification of irrelevant keywords. For example, in a sales conversation the word “expensive” may be mentioned during a small talk as “I had an expensive dinner last night” or in the context of the conversation “your product is too expensive.” In a keyword search, searching “expensive”, both sentences may be detected, but only one of them can be utilized to derive insights with respect to an organization trying to sell a product. Further, the word “expensive” may be mentioned in the conversation in a different context, such as “I cannot afford this product.” Again, such sentences would not be detected by conventional solutions applying keyword searches.

It would therefore be advantageous to provide a solution that would overcome the deficiencies noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for generating a tracker model for identification of trackers in textual data are provided. The method includes receiving an input query including at least an input sentence exemplifying a tracker of interest, wherein the tracker is at least one word with a specific context; generating a base results set including a set of sentences substantially matching the input sentence, wherein the sentences in the base results set are obtained from an index indexing textual data; deriving a first labeling set from the base results set, wherein includes samples of sentences from the base results set; receiving labels on each sentence in the first labeling set; and feeding the labels to a machine learning algorithm to train the tracker model, wherein the tracker model is generated and ready when enough labels have been processed by the machine learning algorithm.

Certain embodiments disclosed herein include a system for generating a tracker model for identification of trackers in textual data. The system comprises a processing circuitry; and a memory, the memory containing instructions that, when executed by the processing circuitry, configure the system to: receive an input query including at least an input sentence exemplifying a tracker of interest, wherein the tracker is at least one word with a specific context; generate a base results set including a set of sentences substantially matching the input sentence, wherein the sentences in the base results set are obtained from an index indexing textual data; derive a first labeling set from the base results set, wherein includes samples of sentences from the base results set; receive labels on each sentence in the first labeling set; and feed the labels to a machine learning algorithm to train the tracker model, wherein the tracker model is generated and ready when enough labels have been processed by the machine learning algorithm.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various disclosed embodiments.

FIG. 2 a framework illustrating the generation and application of a tracker model used for classifying and identifying of one or more trackers in textual data according to an embodiment.

FIG. 3 is a diagram of index of vectors representing sentences generated according to an embodiment.

FIG. 4 is a flowchart illustrating the generation of the tracker model according to an embodiment.

FIG. 5 is a flowchart illustrating a method for generating an index of vectors representing sentences according to an embodiment.

FIG. 6 is a schematic diagram of an index generator according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments present a system and method for identifying trackers in textual data. A tracker, as defined herein, is a keyword or phrase with a specific context. A tracker provides a general concept of a word or phrase. For example, a tracker may be a “pricing objective.” The pricing objective may encompass keywords, such as “expensive,” “high-priced,” “overpriced,” “overrated,” or phrases, such as “it is too expensive,” “I can't afford that,” and so on.

In an example embodiment, the identification of trackers in the textual data is performed using a machine learning classification model (hereinafter a “tracker model”). The tracker model is trained based on a small subset of labeled samples, thereby generating the classification model quickly while conserving computation resources.

The tracker model is trained to identify trackers in the textual data. That is, words or phrases with similar meanings will be classified or identified as a tracker. However, words mentioned in a different context will not. For example, the sentence “the feature is overrated” and “the product is expensive” would be classified as the same tracker (e.g., a pricing objective). Whereas the “this restaurant is overrated” and “the product is expensive” would be classified as different trackers. Thus, the disclosed embodiments improve the accuracy of keyword identification in textual data when the correct context is critical to generate meaningful insights. The various disclosed embodiments will be discussed in detail below.

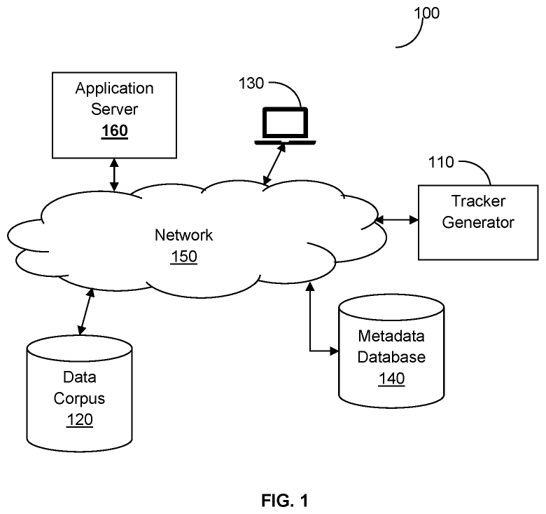

FIG. 1 shows an example network diagram 100 utilized to describe the various disclosed embodiments. In the example network diagram 100, a tracker generator 110, a data corpus 120, a user terminal 130, a metadata database 140 connected to a network 150. In one configuration, an application server 160 is also connected to network 150. The network 150 may be, but is not limited to, a wireless, a cellular or wired network, a local area network (LAN), a wide area network (WAN), a metro area network (MAN), the Internet, the worldwide web (WWW), similar networks, and any combination thereof.

The data corpus (or simply “corpus”) 120 includes textual data from transcripts, recorded calls or conversations, email messages, other types of textual documents. It should be appreciated that the transcripts are often included errors due to noises in the recordings or other effects affecting the voice-to-text recognition. In the example embodiment, the textual data in the corpus 120 includes sales records. The data corpus 120 may further include the trackers generated by the tracker generator 110.

The metadata database 140 may include metadata on calls transcribed or other data stored in the corpus 120. In an embodiment, metadata may include information retrieved from customer relationship management (CRM) systems or other systems that are utilized for keeping and monitoring deals. Examples of such information includes participants in the call, a stage of a deal, date stage, and so on. The metadata may be used in the training processing of the tracker model.

The user terminal 130 allows a user, during a training phase, to enter phrases or keywords of interest, confirm labeling or label certain sentences, to train the tracker model. Once the tracker model is ready, the user through the user terminal 130 can query the tracker model to identify the trackers in the data corpus 120. Such queries can be processed by the application server 160. The application server 160, in some configurations, can process or otherwise analyze the textual data in the corpus 120 based on the identified trackers. For example, the application server 160 can execute applications to flag all conversations identified with a pricing objective tracker.

According to the disclosed embodiments, the tracker generator 110 is configured to create tracker models. The tracker model can be generated per tracker. The tracker generator 110 can classify or otherwise identity tracker(s) in the textual data stored in the corpus 12. This may be performed in response to an application executed by the application server 160. The operation of tracker generator 110 for generating (and training) models are discussed in greater detail below.

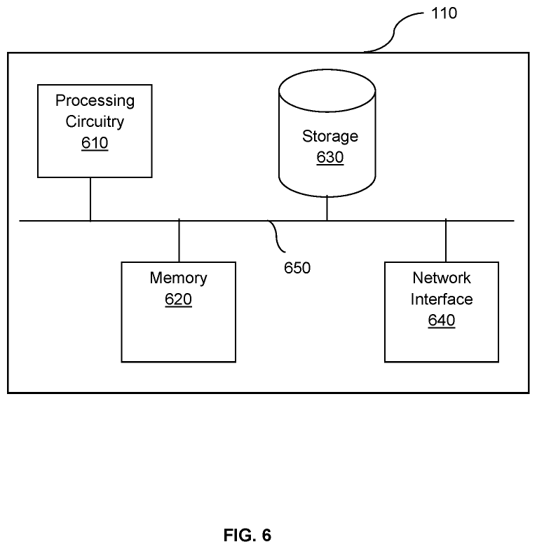

The tracker generator 110 may be realized as a physical machine (an example of which is provided in FIG. 6), a virtual machine (or other software entity) executed over a physical machine, and the like.

It should be noted that the elements and their arrangement shown in FIG. 1 are shown merely for the sake of simplicity. Other arrangements and/or a number of elements should be considered without departing from the scope of the disclosed embodiments. For example, the tracker generator 110, the corpus 120, and the application server 160 may be part of one or more data centers, server frames, or a cloud computing platform. The cloud computing platform may be a private cloud, a public cloud, a hybrid cloud, or any combination thereof.

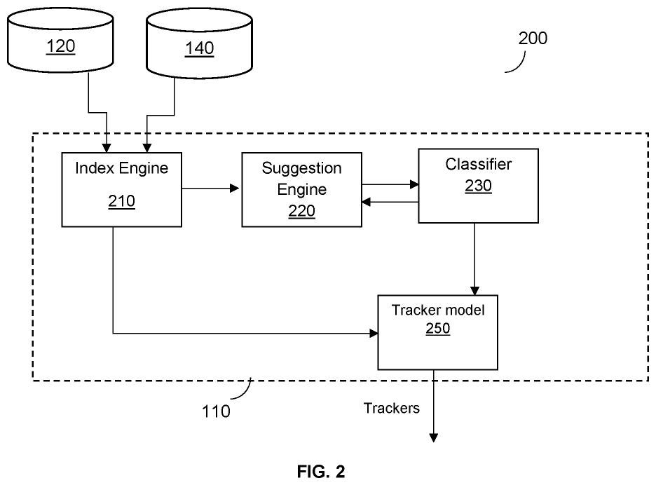

FIG. 2 is an example framework 200 illustrating the generation and application of a tracker model 201 used to classify and identify one or more trackers in textual data according to an embodiment. For simplicity and without limitation of the disclosed embodiments, FIG. 2 will also be discussed with reference to the elements shown in FIG. 1.

The framework 200 operates in two phases: learning and identification. In the learning phase, a tracker model 201 is generated and trained, in the identification phase, the trained model 250 is utilized for the identification of one or more trackers in transcripts of conversations or other textual data saved in the corpus 120.

As illustrated in FIG. 2, the framework 200 includes an index engine 210, a suggestion engine 220, and a classifier 230 being to output the tracker model 250. Here, the classifier 230 is a supervised machine learning use by machines (e.g., GPUs) to classify data. The tracker model 250 is an output of the classifier's 230 machine learning algorithm. The tracker model 250 is trained using the classifier 230, so that the model, ultimately, classifies textual data to identify trackers.

In an embodiment, the tracker model 250 is a supersized machine learning model that can be utilized to identify tracker(s) in transcribed conversations. In an example embodiment, the tracker model 250, once trained allows classification of future conversations. The tracker model 250 is trained per a tracker (e.g., a pricing objective).

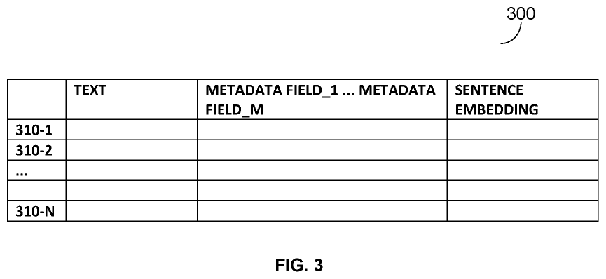

The index engine 210 is connected to the data corpus 120 and metadata database 140. The index engine 210 is configured to process data in the corpus 120 to output an index of transcribed calls (or other textual data). An example of index 300 is shown in FIG. 3. The index 300 includes a plurality of entries 310-1 through 310-N. Each entry 310 represents a vector for a sentence and includes a sentence (text), one or more metadata fields, and a vector representation (embedding value) of the sentence. The metadata is retrieved from the metadata database 140 and may include a specific time in the conversation that the sentence was said, participants in the calls, their locations, stage in the deal, the topic of any other information from a CRM system associated with the call, or information associated with the call.

As an example, the data an entry 310 may include the following:

Sentence (text): “If we buy 100 licenses, do we get a discount?”

### Metadata Fields:

Deal type: New Business
Deal stage: Negotiation
Tier: SMB
Topic: Pricing
Time in call: 00:36:24/00:56:00
Affiliation: Company
   Word Embedding: [−2.10331809e−02, −2.06176583e−02, 6.59231246e−02 . . . 8.64016078e−03, −7.70692620e−03, 6.42301515e−02]

In an embodiment, the index engine 210 is configured to first split the textual data in the corpus into sentences. Each sentence is preprocessed to have a unified representation. In an example embodiment, the preprocessing includes removing disfluencies, normalizing dates and/or number notation, capitalizing names, and so on. For example, all dates can be converted into <yyyy,mm,dd> format. Clearing of disfluencies is performed on transcripts. The purpose of preprocessing sentences is to remove noise from the text being processed. It should be noted that entries 310 in the index 310 are not ordered in a specific order.

The index engine 210 is further configured to generate a vector representation (sentence embedding) for each sentence. The vector representation may be performed using sentence or word embedding techniques discussed in the related art. For example, sentence embedding is a representation of document vocabulary that allows capturing the context of a word in a document, semantic and syntactic similarity, relation with other words, and so on. Using sentence word embedding, words are represented as real-valued vectors in a predefined vector space. Each word is mapped to one vector, and the vector values are learned in a way that resembles, for example, a neural network. Sentence or word embedding techniques that can be utilized by the index engine 210 may include embeddings from language model (ELMo), bidirectional encoder representations from transformers (BERT), and the like.

To complete an entry, relevant metadata information to the respective sentence is obtained from the metadata database 140 and associated with the sentence and its vector representation. The suggestion engine 220 is configured to receive input queries from a user through the user terminal 130. Each such input query may include one or more sentences that express a potential tracker of interest. The user may also provide metadata fields for filtering certain conversations in the corpus 120. An example for an input query may be:

Sentence (text): Can we do something to lower the price? Is there any flexibility in terms of pricing? Would it be possible to get a better quote?]

### Metadata Field:

Tier: SMB
Affiliation: Company
   Where “tier” and “affiliation” are metadata fields.

The suggestion engine 220 is further configured, for each input query, to compute its vector representation. This may be performed using one of the sentence embedding techniques mentioned above. The suggestion engine 220 is configured to obtain from the index (e.g., 310) a set of vectors satisfying the vector representation of the input query. This is performed by requesting the index engine 210 to return all vectors substantially matching the input query's vector representation and potentially metadata fields provided by the user. The results returned by the index engine 210 are referred to hereinafter as a “base results set.”

In an embodiment, the sentences to be included in the base results set are determined based on a computed distance between each sentence (represented by its sentence embedding value) in the index and the input query's sentences (represented by its sentence embedding value). Specifically, the distance may be computed as an aggregate function (e.g., a mean function, a maximum function, etc.) over the distances between the respective sentence embedding values (of each entry in the index and an input query's sentence).

The suggestion engine 220 is further configured to compute and output a labeling set derived from the base results set. The labeling set includes a small number of sentences to be labeled. In an example embodiment, the number of sentences in a labeling set is less than 20. In contrast, the base results set includes hundreds of sentences. In an example embodiment, sentences in the labeling set are provided, for example, to the user to label the relevancy to the input query.

The sentences in the labeling set may be selected such that they are varied but still in the general scope of the input query's sentence. In an embodiment, the selection may be performed by clustering the sentence embedding values of respective sentences included in the base results set. The clustering is performed such that small, compact clusters are formed. Since close vectors have similar semantic meanings, such clusters presumably demonstrate synonymous meaning. In an embodiment, one sentence from each cluster is selected to be included in the labeling set. It should be noted that clusters that are distant enough from each other, but not too distant from the original input sentences are sampled for the creation of the labeling set.

Collectively or alternatively to the clustering technique, sentences in the labeling set may be selected based on a simplified machine learning model being trained on the spot as the user provides feedback on an initial set of sentences. Such a model can be programmed to infer candidate sentences from all sentences in the base results set. It should be noted that the suggestion engine 220 is configured to iteratively generate labeling sets until the tracker model 250 is trained.

According to the disclosed embodiments, sentences in a labeling set are presented to a user through, for example, the user terminal 130. The user is requested to label such sentences by indicating if each sentence is related, unrelated, or somehow related to the input query's sentence. In an example configuration, a graphical user interface (GUI) may be provided for the labeling request for the user to the select an option, or provide a score (e.g., 1-5) based on relevance.

The labeled sentences are fed to the classifier 230 for the training of the tracker model 250. In addition, the classifier 230 is configured to score the sentences in the base results set. In an example embodiment, a higher score signifies a stronger affinity to a tracker of interest. This is performed to allow the selection of different sentences to be included in a subsequent labeling set. The selected subsequent sentences may be a mix of sentences with confidence of relevancy and some with uncertainty about the relevancy.

The training of the model (based on the labeling sets) continues until it is determined that the tracker model 250 is well trained. This decision on when to stop the training may be taken by the user or after a predefined number of iterations is completed.

In some example embodiments, the classifier 230 may be realized using a neural network, a deep neural network programmed to run a supervised machine learning. The supervised machine learning algorithms may include, for example, a k-nearest neighbors (KNN) model, a gaussian mixture model (GMM), a random forest, manifold learning, decision trees, support vector machines (SVM), decision trees, label propagation, local outlier factor, isolation forest, and the like.

In an embodiment, the trained tracker model 250 is used to identify trackers in future transcripts (or other textual data) stored in the data corpus 120. Future textual data refers to any data stored after the model 250 is trained or data not used for the training of the trained tracker model 250. To this end, the processing of sentences fed into the trained tracker model 250 is performed by the index engine 210 as discussed above. That is, the trained tracker model 250 is operational in the identification phase of the framework 200.

The trained tracker model 250 may be executed using the same neural network and the supervised machine learning as the classifier 230. Examples for supervised machine learning algorithms are provided above.

It should be noted that in some configurations, the index engine 210, suggestion engine 220, classifier 230 are elements of the tracker generator 110. It should be further noted that the index engine 210, suggestion engine 220, and/or classifier 230 can be realized as or executed by as one or more hardware logic components and circuits. For example, and without limitation, illustrative types of hardware logic components that can be used include field-programmable gate arrays (FPGAs), application-specific integrated circuits (ASICs), application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

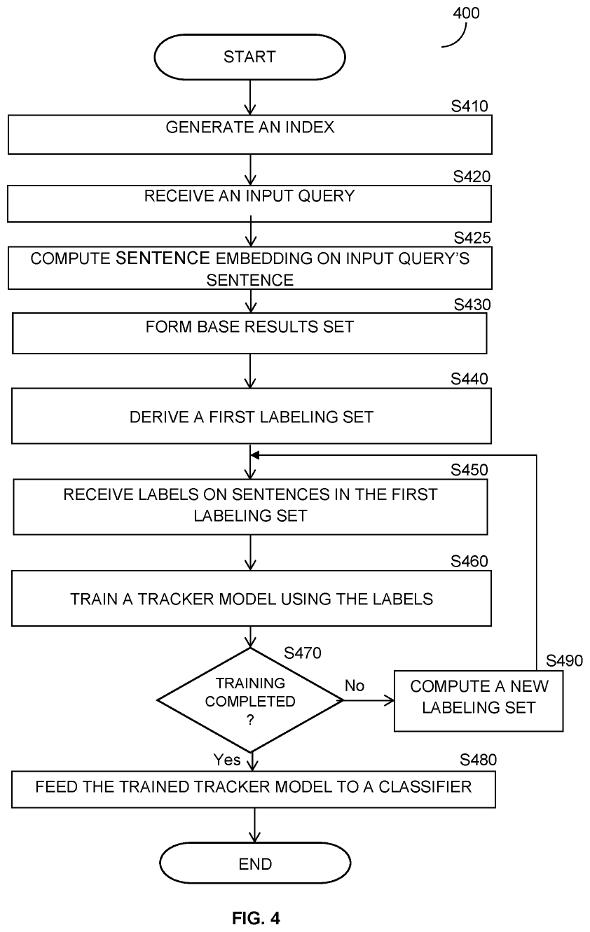

FIG. 4 is an example flowchart 400 illustrating the generation of the tracker model according to an embodiment. The tracker model allows the application of identifying keywords and phrases with the same context in textual data. The textual data may include text records, such as transcripts of sales calls, emails, text messages, and the like.

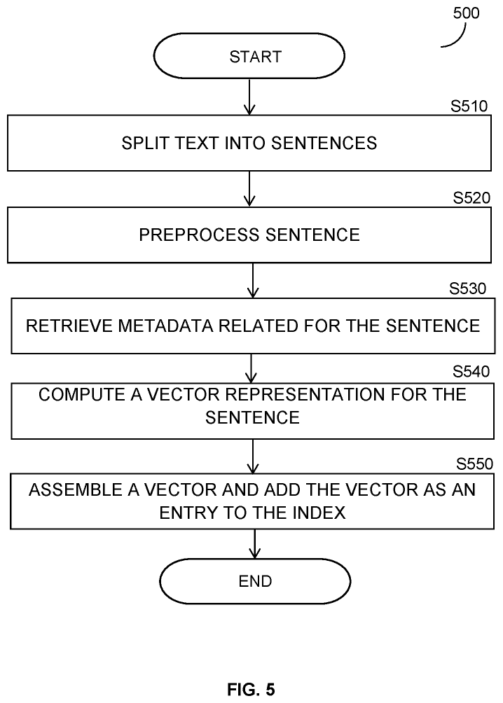

At S410, the text data saved, for example, in a corpus, is processed to generate an index. An index includes a plurality of entries, each entry represents a vector. As demonstrated in FIG. 3, an entry includes a sentence (text), metadata fields, and sentence embedding values of the text. An index is generated per tenant (customer) having stored data in the corpus. It should be noted S410 can be performed in the background and independent of the training the model. The operation of S410 is further discussed with reference in FIG. 5.

At S510, the text is split into sentences. To this end, each call transcript or email is divided into sentences. Sentences may be detected in the text based on punctuation, moments of silence, speakers changes, and so on.

At S520, each sentence is preprocessed to clean noise. This includes removing disfluencies, normalizing dates and/or numbers notation, capitalizing names, and so on. At S530, metadata related to the sentence is retrieved from a database. The metadata may include, for example, information from a CRM system having records related to the conversation (or email) that the sentence was taken from. Examples of metadata values and fields are provided above. At S540, a vector representation which is an embedding value, is computed over the sentence. At S550, a vector is assembled and added as an entry to the index. The vector, and hence the entry, include the sentence, metadata fields, and an embedding value. It should be noted that S520 through S550 is performed for each sentence identified at S510.

Returning to FIG. 4, where at S420, an input query is received. The input query includes a sentence exemplifies a tracker of interest. At S425, a sentence embedding value of the input query's sentence is computed.

At S430, a base results set is formed. In an embodiment, this includes computing the distance between the sentence embedding value of the input query's sentence and each vector's embedding value in the index. The distance may be computed, for example, using an aggregated function. In an embodiment, each computed distance less a predefined threshold is added to the base results set. For example, the input query's sentence is:
“Can we do something to lower the price?”
   Word Embedding: [0.002]
      The index includes the following vectors (saved in the index's entry):
1. “this burger is too expensive.”
   Word Embedding: [0.7]
2. “the product is great, but doesn't meet our budget.”
   Word Embedding: [0.003]
      The distance between the input sentence, computed using a maximum function, to sentence (1) is 0.7, and the distance between the input sentence to sentence (2) is 0.003. Thus, sentence (2) is closer (minimum distance) to the input sentence and will be added to the base results set. In an embodiment, sentences to be included in the base results set can be determined using a K-nearest neighbors (KNN) algorithm.

At S440, a first labeling set is derived from the base results set. The number of sentences in a first labeling set is significantly less than the number of sentences (vectors) in the base results set. In an embodiment, the first labeling set is selected by clustering vectors in the base results set. For example, a hierarchical clustering algorithm can be utilized to find clusters of similar vectors. A hierarchical clustering is an algorithm of cluster analysis that seeks to build a hierarchy of clusters. Strategies for hierarchical clustering may generally include an agglomerative approach where each observation starts in its own cluster, and pairs of clusters are merged as one moves up the hierarchy; and a divisive approach where all observations start in one cluster, and splits are performed recursively as one moves down the hierarchy. In general, the merges and splits are determined in a greedy manner. The results of hierarchical clustering are usually presented in a dendrogram.

Then, from each cluster, a sample sentence is selected and added to the first labeling set. It should be noted that clusters determined to be far (i.e., the distance over a predefined threshold) are not considered for the labeling set. It should be further noted that a vector is an entry in the generated index that includes all data mentioned above.

At S450, a label input on each sentence included in the first labeling set is received. In an example embodiment, a user is prompted to provide the input label in the form of how relevant a sentence is to the tracker of interest.

At S460, a tracker is model trained using the input labels. Further, the input labels are sent to a labeling model that can be utilized in generate a new labeling set.

At S470, it is checked if the tracker model is trained and ready for use in an identification mode. If so, execution continues with S480, where the trained tracker model is fed into a classifier configured to identify the tracker in future conversations (i.e., new textual data added to the corpus). For example, if the tracker is “pricing objective”, all calls that include the concept of “pricing objective” are identified. A list of such calls can be output and displayed to the user. Otherwise, at S490, a new labeling set is computed, and execution is returned to the S450. The new labeling set can be computed using the labeling model, the hierarchical clustering algorithm, or both. These techniques are discussed in detail above.

FIG. 6 is an example schematic diagram of the tracker generator 110 according to an embodiment. The tracker generator 110 includes a processing circuitry 610 coupled to a memory 620, a storage 630, and a network interface 640. In an embodiment, the components of the tracker generator 110 may be communicatively connected via a bus 650.

The processing circuitry 610 may be realized as one or more hardware logic components and circuits. For example, and without limitation, illustrative types of hardware logic components that can be used include field-programmable gate arrays (FPGAs), application-specific integrated circuits (ASICs), application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 620 may be volatile (e.g., random access memory, etc.), non-volatile (e.g., read-only memory, flash memory, etc.), or a combination thereof.

In one configuration, software for implementing one or more embodiments disclosed herein may be stored in storage 630. In another configuration, the memory 620 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 610, cause the processing circuitry 610 to perform the various processes described herein.

The storage 630 may be magnetic storage, optical storage, and the like, and may be realized, for example, as flash memory or other memory technology, compact disk-read-only memory (CD-ROM), Digital Versatile Disks (DVDs), or any other medium which can be used to store the desired information.

The network interface 640 allows the tracker generator 110 to communicate with other elements over the network 150 for the purpose of, for example, receiving data, sending data, and the like.

It should be understood that the embodiments described herein are not limited to the specific architecture illustrated in FIG. 6, and other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer-readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

What is claimed is:

1. A method for generating a tracker model for identification of trackers in textual data, comprising:
receiving an input query including at least an input sentence exemplifying a tracker of interest, wherein the tracker is at least one word with a specific context;
generating a base results set including a set of sentences substantially matching the input sentence, wherein the sentences in the base results set are obtained from an index indexing textual data;
deriving a first labeling set from the base results set, wherein includes samples of sentences from the base results set;
receiving labels on each sentence in the first labeling set; and
feeding the labels to a machine learning algorithm to train the tracker model, wherein the tracker model is generated and ready when enough labels have been processed by the machine learning algorithm.

2. The method of claim 1, wherein when the tracker model is not ready further comprising:
iteratively generating a second labeling set from the base results;
receiving labels on each sentence in the second labeling set; and
feeding the labels to the machine learning algorithm to further train the tracker model.

3. The method of claim 1, further comprising:
indexing textual data stored in a corpus to generate the index.

4. The method of claim 3, wherein indexing the textual data further comprises:
splitting each record in the corpus into a plurality of sentences;
computing a vector representation to each of the plurality of sentences;
associating metadata fields with the vector representation, wherein the vector representation includes a sentence embedding value; and
saving a sentence with its respective vector representation and metadata fields as a vector included in as entry in the index.

5. The method of claim 4, wherein records in the corpus includes at least transcripts of calls and email messages related to sales in an organization.

6. The method of claim 5, wherein the metadata fields are retrieved from a customer relationship management (CRM) system of the organization.

7. The method of claim 1, wherein generating the base results set further comprises:
computing a sentence word embedding value to the input sentence;
determining, based on their respective sentence embedding values, all sentences in the index that close to the sentence embedding value of the input sentence; and
including all the determined sentences in the base results setting.

8. The method of claim 1, wherein deriving the first labeling set further comprises:
clustering, based on their respective sentence embedding values, the base results set; and
selecting a sample sentence from each eligible cluster to be included the first labeling set.

9. The method of claim 2, further comprising:
generating the second labeling set from the base results set and labels generated based on the first labeling set.

10. The method of claim 1, further comprising:
receiving a transcript of a new sales call; and
identifying, using the tracker model, a tracker in the transcript of a new sales call.

11. A non-transitory computer readable medium having stored thereon instructions for causing a processing circuitry to execute a process for live migration of an index in a document store, the process comprising:
receiving an input query including at least an input sentence exemplifying a tracker of interest, wherein the tracker is at least one word with a specific context;
generating a base results set including a set of sentences substantially matching the input sentence, wherein the sentences in the base results set are obtained from an index indexing textual data;
deriving a first labeling set from the base results set, wherein includes samples of sentences from the base results set;
receiving labels on each sentence in the first labeling set; and
feeding the labels to a machine learning algorithm to train the tracker model, wherein the tracker model is generated and ready when enough labels have been processed by the machine learning algorithm.

12. A system for generating a tracker model for identification of trackers in textual data, comprising:
a processing circuitry; and
a memory, the memory containing instructions that, when executed by the processing circuitry, configure the system to:
receive an input query including at least an input sentence exemplifying a tracker of interest, wherein the tracker is at least one word with a specific context;
generate a base results set including a set of sentences substantially matching the input sentence, wherein the sentences in the base results set are obtained from an index indexing textual data;
derive a first labeling set from the base results set, wherein includes samples of sentences from the base results set;
receive labels on each sentence in the first labeling set; and
feed the labels to a machine learning algorithm to train the tracker model, wherein the tracker model is generated and ready when enough labels have been processed by the machine learning algorithm.

13. The system of claim 12, wherein when the tracker model is not ready further, the system is further configured to:
iteratively generate a second labeling set from the base results;
receive labels on each sentence in the second labeling set; and
feed the labels to the machine learning algorithm to further train the tracker model.

14. The system of claim 12, wherein the system is further configured to:
index textual data stored in a corpus to generate the index.

15. The system of claim 14, wherein the system is further configured to:
split each record in the corpus into a plurality of sentences;
compute a vector representation to each of the plurality of sentences;
associate metadata fields with the vector representation, wherein the vector representation includes a sentence embedding value; and
save a sentence with its respective vector representation and metadata fields as a vector included in as entry in the index.

16. The system of claim 15, wherein records in the corpus includes at least transcripts of calls and email messages related to sales in an organization.

17. The system of claim 16, wherein the metadata fields are retrieved from a customer relationship management (CRM) system of the organization.

18. The system of claim 12, wherein the system is further configured to:
compute a sentence word embedding value to the input sentence;
determine, based on their respective sentence embedding values, all sentences in the index that close to the sentence embedding value of the input sentence; and
include all the determined sentences in the base results setting.

19. The system of claim 12, wherein the system is further configured to:
cluster, based on their respective sentence embedding values, the base results set; and
select a sample sentence from each eligible cluster to be included the first labeling set.

20. The system of claim 12, wherein the system is further configured to:
generate the second labeling set from the base results set and labels generated based on the first labeling set.

21. The system of claim 12, wherein the system is further configured to:
receive a transcript of a new sales call; and
identify, using the tracker model, a tracker in the transcript of a new sales call.
